(19) United States
(12) Patent Application Publication
(10) Pub. No.: US 2015/0032810 A1
(43) Pub. Date: Jan. 29, 2015

(54) CONTENT DISTRIBUTION USING SOCIAL RELATIONSHIPS

(71) Applicant: MICROSOFT CORPORATION, Redmond, WA (US)

(72) Inventors: Brandon T. HUNT, Redmond, WA (US); Frank R. MORRISON, III, Kirkland, WA (US); Alexander BURBA, Seattle, WA (US); Michael Joffre GALLOP, Sammamish, WA (US)

(73) Assignee: MICROSOFT CORPORATION, Redmond, WA (US)

(21) Appl. No.: 13/953,159

(22) Filed: Jul. 29, 2013

(51) Int. Cl. H04L 12/911

(52) U.S. Cl. CPC H04L 47/70
USPC 709/204

(57) ABSTRACT

Embodiments of the present invention enable users to allocate resources on their client devices according to relationships with other users. Resources include content such as games or movies. In one embodiment, a content provider directs a requesting device to a peer device that has access to the requested content. When users are in a social relationship, the users' devices are said to be socially affiliated. A user's social network is a collection of the user's electronic relationships with other people. Embodiments of the present invention allow users to establish sharing preferences for one or more client devices. In general, a sharing preference gives an individual preferential access to a user's computing resources on the one or more client devices. The access is preferential when compared to access given to nonsocially affiliated computing devices.

### BACKGROUND

A peer-to-peer network is able to allow users to communicate digital content from one computer to another. Digital content may include video games, videos, pictures, music, etc. For example, in a peer-to-peer network, multiple clients throughout the world could connect over a network to retrieve a song file from a client device. One or more users associated with the client devices may form relationships with other users in one or more social networks.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention allocate computing resources in a peer-to-peer network using social network affiliations. Resources include disital content, such as games or movies. In one embodiment, a content provider directs a requesting device to a peer device that has access to the requested content. The content provider may communicate a license to the requesting device and have the peer device communicate the content.

Devices may be described as socially affiliated with one another. Computing devices themselves do not have social relationships, but the users of the various devices do. When users are in a social relationship, the user's devices are said to be socially affiliated. A single user may have multiple devices associated with a social network. For example, each device a user utilizes to access a social network may be associated with the social network.

A social network is a collection of a user's electronic relationships with other people. The electronic relationships may exist within a formal social network such as those provided by Facebook, LinkedIn, and the like. The electronic relationship may be a list of contacts within a personal data manager or email application. The electronic relationship may be formed by regular electronic communications with another user regardless of whether the user is in a contact database. For example, two users who regularly exchanged emails with one another may have an electronic relationship for purposes of this disclosure. In one embodiment, the electronic relationships are formed within a gaming service. Within the gaming service, relationships may be formally recognized in a manner similar to those formed in a formal social network or informally by communicating regularly within the gaming service or participating in the same multiplayer game sessions more than a threshold number of times.

Embodiments of the present invention allow users to establish sharing preferences for one or more client devices. The sharing preferences may be established at different levels of granularity. In general, a sharing preference gives an individual preferential access to a user's computing resources on the one or more client devices. The access is preferential when compared to access given to nonsocially affiliated computing devices. In one embodiment, access to computing resources is only given to socially affiliated computing devices and nonsocially affiliated computing devices are excluded.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a diagram of an online gaming environment, in accordance with an embodiment of the present invention;

FIG. 3 is a diagram of a peer-to-peer gaming computing environment, in accordance with an embodiment of the present invention;

FIG. 4 is a diagram of communications occurring in a peer-to-peer environment, in accordance with an embodiment of the present invention;

FIG. 5 is a flow chart showing a method of allocating computing resources based on social relationships, in accordance with an embodiment of the present invention;

FIG. 6 is a flow chart showing a method of managing allocation of computing resources using social relationships, in accordance with an embodiment of the present invention; and

FIG. 7 is a flow chart showing a method of managing access to computing resources based on social relationships, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention allocate computing resources in a peer-to-peer network using social network affiliations. Resources include content such as games or movies. In one embodiment, a content provider directs a requesting client to a peer device that has access to the requested content. The content provider may communicate a license to the requesting device and have the peer device communicate the content.

In a peer-to-peer network, computing devices that are accessing content from another peer device are described as leeching devices. Computing devices that are providing access to computing resources are described as seeding devices. A single device may alternate between seeding and leeching depending on need. A single device may be a seed and a leech simultaneously.

Devices may be described as socially affiliated with one another. Computing devices themselves do not have social relationships, but the users of the various devices do. Throughout this application, when users are in a social relationship, the user's devices are said to be socially affiliated. A single user may have multiple devices associated with a social network. For example, each device a user utilizes to access a social network may be associated with the social network.

A social network is a collection of a user's electronic relationships with other people. The electronic relationships may exist within a formal social network such as those provided by Facebook, LinkedIn, and the like. The electronic relationship may be a list of contacts within a personal data manager or email application. The electronic relationship may be formed by regular electronic communications with another user regardless of whether the user is in a contact database. For example, two users who regularly exchanged emails with one another may have an electronic relationship for purposes of this disclosure. In one embodiment, the electronic relationships are formed within a gaming service. Within the gaming service, relationships may be formally recognized in a manner similar to those formed in a formal social network or informally by communicating regularly within the gaming service or participating in the same multiplayer game sessions more than a threshold number of times.

Embodiments of the present invention allow users to establish sharing preferences for one or more client devices. The sharing preferences may be established at different levels of granularity. In general, a sharing preference gives an individual preferential access to a user's computing resources on the one or more client devices. The access is preferential when compared to access given to nonsocially affiliated computing devices. In one embodiment, access to computing resources is only given to socially affiliated computing devices and nonsocially affiliated computing devices are excluded.

In addition to all-or-nothing sharing, different levels of access may be given to different individual relations or classes of relationships. For example, a group of close relations may be given access to archival content or more bandwidth than is allocated to others assigned a lower level of priority. In one embodiment, the different levels of access take the form of ranking individuals within the user's social network who have been granted sharing preferences. The ranking may be used to resolve simultaneous or overlapping requests for access to computing resources. In one embodiment, the receipt of a request from a socially affiliated client device that has a higher rank terminates access to a computing device having a lower rank. In another embodiment, a higher rank and lower-ranked computing device continue to have access to computing resources simultaneously, but the higher-ranked computing device is given access to more of the available computing resources. For example, the high-ranked leeching device may be given access to two-thirds of available bandwidth while the lower-ranked leeching device is given access to one-third of the available bandwidth.

In one embodiment, a user's client is able to interrogate or mine a user's social networks to identify relations that are part of a peer-to-peer network from which a desired resource may be obtained. The user may be allowed to opt in or opt out of this service. The user may be asked to provide passwords or other credentials to allow his client device to collect a group of social relations.

Once the social relations are gathered, the user may be provided in interface through which they are able to provide detailed strategies in rules when seeding. One rule may allow no more than a designated number of devices to leech at one time. Another rule may allow each socially affiliated device to consume a designated percentage of available bandwidth. As mentioned, different groups of socially affiliated devices may be allocated a different portion of bandwidth. In one embodiment, nonsocially affiliated devices are allowed to leech until a leech request is received from a socially affiliated leech.

In one embodiment, power-saving functions are integrated into the sharing preferences. Computing devices may enter a power-saving mode from time to time. For example, after not being used for a threshold period of time, a device may enter power-saving mode. Sharing preferences may specify whether a device may act as a seed when in power-saving mode. This preference may be defined to take the device out of power-saving mode in order to act as a seed for some relations and not others.

Archival integration offers another opportunity to provide access to a computing resource for some but not others. Content that is associated with the computing device may be archived. For example, content may be stored in an external hard drive that is communicatively coupled to a client device. Sharing the archive content may be more resource intensive than sharing content stored in the client device's memory. Accordingly, a user may wish to restrict archival access to a smaller group of relations.

In one embodiment, a provision is made for sharing preferences to be granted in a reciprocal nature. In other words, a user may choose to grant sharing preferences only on the condition that a relation reciprocates and provides sharing preferences to the user. In one embodiment, a user may choose to adjust the rank or grouping of an individual that provides the user sharing preferences.

Upon granting sharing preferences to an individual, a notification may be sent to one or more of the individual's client devices. The notification may be stored on the client devices and used to generate a list of potential seeds the next time access to computing resources is needed. The notification may come with an opportunity or link that allows the recipient to provide reciprocal sharing preferences.

Client devices may provide an interface that allows a user to rank seeds that have granted sharing preferences. The user may wish to link seeds that are deemed reliable. The ranking is used to send requests for access to computing resources. Requests are first sent to associate socially affiliated computing devices having the highest rank. The rank may be adjusted based on a device's performance as a seed. For example, a device having a limited bandwidth connection that interferes with a content transfer or having limited access to another computing resource may be given a lower rank. Ranks and performance scores may be held separately.

In one embodiment, an opportunity is given to allow relations of relations to have preferential access. A relation of the relation may be deemed more reliable by virtue of a relationship with a trusted party. In one embodiment, an incentive is given to users who establish sharing preferences. In one embodiment, a greater benefit is given based on the number of people and quality of sharing preferences granted. The benefit may take the form of an achievement or recognition within a social network or service. For example, a content provider may provide access to additional content as a reward for sharing content with other users on behalf of the content provider.

In one embodiment, the sharing preferences allow the user to establish a time window during which the client device may be used as a seed. For example, the user may not wish to grant access to computing resources on her client device when she is using the device. Thus, the time windows may be established four times that of anticipated low personal usage. Embodiments are not limited to establishing time windows during periods of low personal usage. Time windows may be established based on user preference.

Having briefly described an overview of embodiments of the invention, an exemplary operating environment suitable for use in implementing embodiments of the invention is described below.

### Exemplary Operating Environment

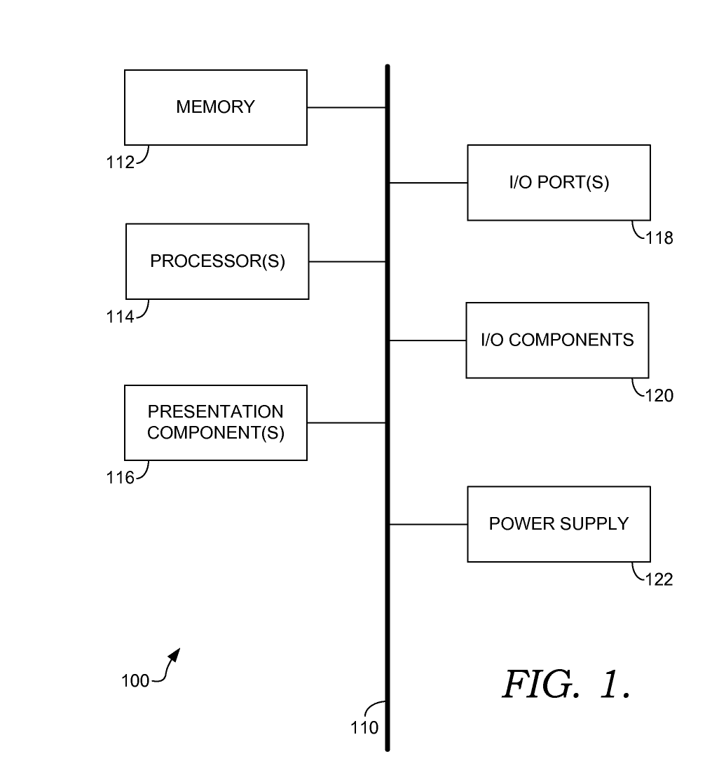

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

### Exemplary Online Gaming Environment

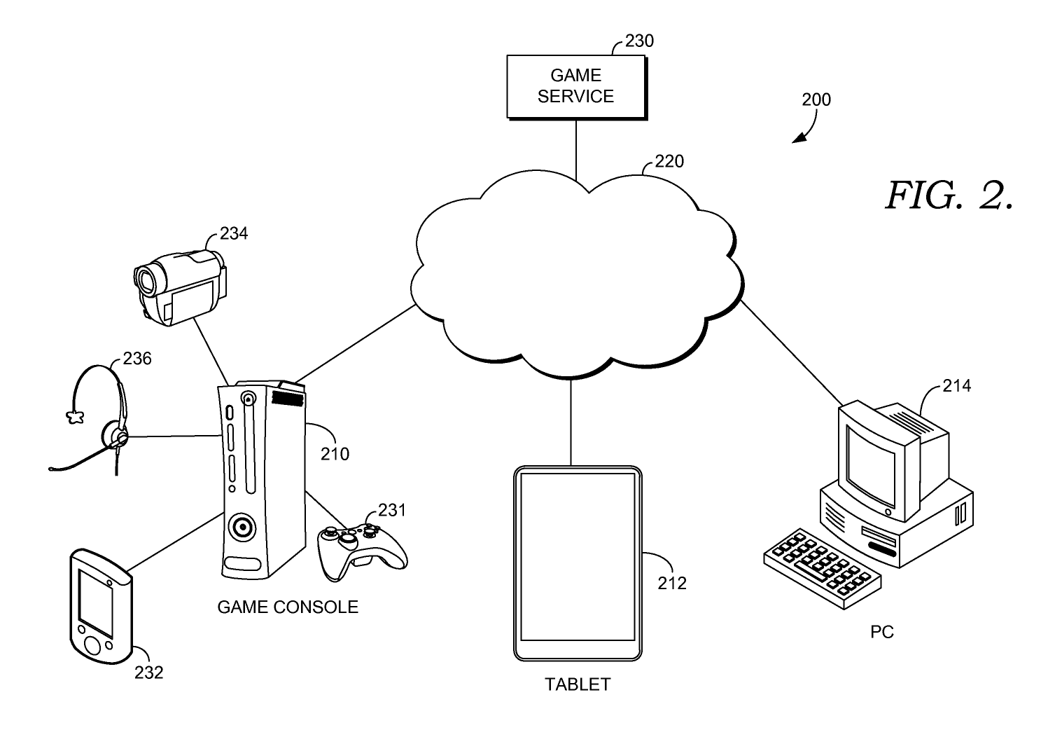

Turning now to FIG. 2, an online gaming environment 200 is shown, in accordance with an embodiment of the present invention. Online gaming environment 200 may be a peer-to-peer environment. The online gaming environment 200 comprises various game clients connected through a network 220 to a game service 230. Exemplary game clients include a game console 210, a tablet 212, and a personal computer 214. Use of other game clients, such as smart phones, are also possible. The game console 210 may have one or more game controllers communicatively coupled to it. In one embodiment, the tablet 212 may act as an input device for a game console 210 or a personal computer 214. In another embodiment, the tablet 212 is a stand-alone game client. Network 220 may be a wide area network, such as the Internet.

The controllers associated with game console 210 include game pad 231, tablet 232, headset 236, and depth camera 234. A game console may be associated with control devices that generate both a rich input and a basic input. Individual controllers are capable of generating different kinds of inputs and a single controller could generate both a rich input and an basic input.

The game pad 231 may be capable of generating basic control signals, such as those generated by button selections and joystick movement. Movement data such as that generated by accelerometers and gyros within the game pad 231 may be examples of rich sensory data. In some implementations, the movement data is not considered a rich sensory data.

The tablet 232 can be both a game controller and a game client as mentioned previously with tablet 212. Tablet 232 is shown coupled directly to the game console 210, but the connection could be indirect through the Internet or a subnet. In one embodiment, the game service 230 helps make a connection between the tablet 232 and the game console. The tablet 232 is capable of generating numerous input streams and may also serve as a display output mechanism. In addition to being a primary display, the tablet 232 could provide supplemental game information near information shown on a primary display coupled to the game console 210, or simply be a control surface. The input streams generated by the tablet 232 include video and picture data, audio data, movement data, touch screen data, and keyboard input data.

The headset 236, captures audio input from a player and the player's surroundings and may also act as an output device if it is coupled with a headphone or other speaker.

The depth camera 234 generates a depth cloud used as a control input. The depth camera 234 may an use infrared camera to determine a depth, or distance from the camera for each pixel captured. Stereoscopic depth cameras are also possible. In addition, the depth camera 234 may capture a typical color stream or picture. The depth camera 234 may have several image gathering components. For example, the depth camera 234 may have multiple cameras.

Game service 230 may comprise multiple computing devices communicatively coupled to each other. In one embodiment, the game service 230 is implemented using one or more data centers. The data centers may be spread out across various geographic regions including cities throughout the world. In this scenario, the game clients may connect to the closest data centers. Embodiments of the present invention are not limited to this setup.

### Exemplary Game Client and Game Service for Remote Gaming

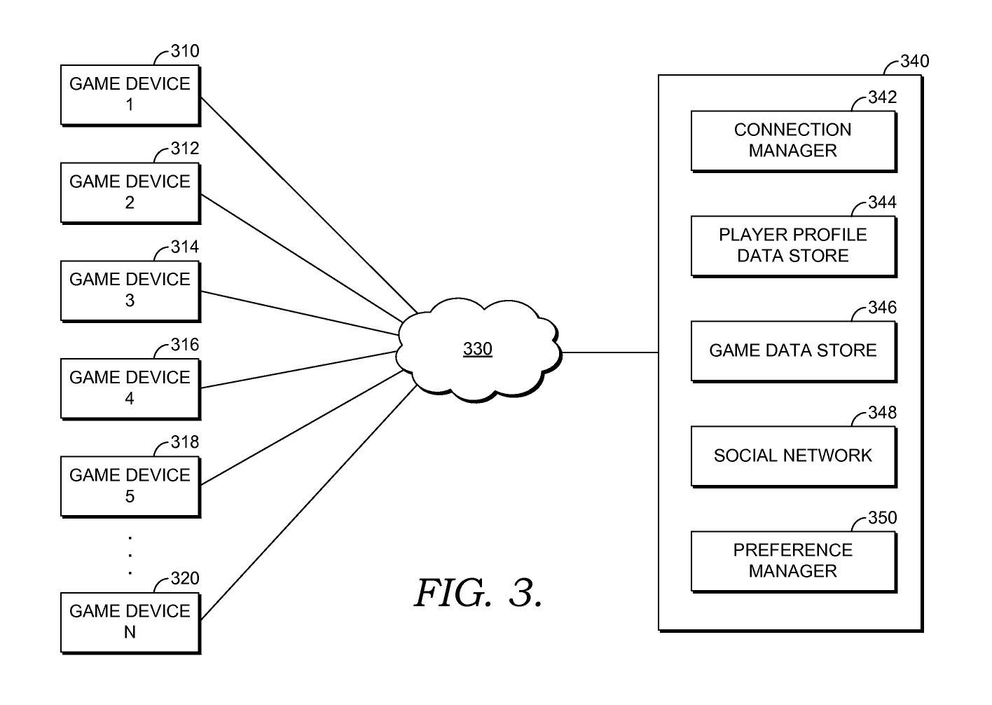

Turning now to FIG. 3, an exemplary remote gaming environment 300 is shown, in accordance with an embodiment of the present invention. The remote gaming environment 300 includes a game device 1 310, game device 2 312, game device 3 314, game device 4 316, game device 5 318, game device N 320, communicatively coupled to a game server 340 through a network 330. In one embodiment, the network may be the Internet. Each game device may be connected to one or more input devices and a display. Exemplary game input devices include game pads, keyboards, a mouse, a touch pad, a touchscreen, a microphone for receiving voice commands, a depth camera, a video camera, and a trackball. Embodiments of the present invention are not limited to these input devices. The display is capable of displaying media content, including video game content. For example, the display may be a television or a computer screen. In another embodiment, the display is a touchscreen integrated with the game device.

Each game device 310, 312, 314, 316, 318, and 320 is a computing device that is able to execute video games. The game device could be a tablet or a laptop computer. In another embodiment, the game device is a game console. The game device includes an operating environment, a video graphic component, a game data store, and the like. The game devices may have peer-to-peer management software that facilitates foreign connections with other computing devices. The peer-to-peer management software may allow the user to enumerate sharing preferences, track performance of seed devices, and determine which devices to pursue as a seed device. Peer-to-peer management software may also consider a user's rankings and past performance when sending out requests to access computing resources on another computer.

The operating environment on a game device may be provided by an operating system that manages the hardware and provides services to applications running on the game device. The operating environment may allocate client resources to different applications as part of game and communication functions. The data store on the game device stores downloaded games, game samples, and/or partially downloaded games, videos, applications, music, and other content.

The game execution environment comprises the gaming resources on the game device that are required to execute instances of a game or part of a game. In some embodiments, the game device does not include a game execution environment or the computing resources to execute the game. A game execution environment comprises active memory along with computing and video processing resources. The game execution environment receives gaming controls and causes the game to be manipulated and progressed according to game programming. In one embodiment, the game execution environment outputs a rendered video stream that is communicated to a display.

The game server 340 is one form of content server that may interact with embodiments of the invention. A game server was chosen for the sake of illustration, but an e-book distributor, video distributor, or any other content provider may use embodiments of the invention. In one embodiment, the game server 340 connects a device requesting content to a peer device that already has access to the content. The content is then provided to the requesting device by the peer device instead of the game server 340.

The game server comprises a connection manager 342, a player profile data store 344, a game data store 346, a social network manager 348, and a preference manager 350. Though depicted as a single box, the game server 340 could be a data center that comprises numerous machines, or even several data centers. Several of the servers could act as clients for a central server.

The connection manager 342 builds a connection between the game devices and the game server 340. The connection manager 342 may also provide various authentication mechanisms to make sure that the user is authorized to access the game service provided by the game server 340 and to join a peer-to-peer network. The connection manager may provide security, encryption, and authentication information to servers and game devices as they connect to the game network. The connection manager 342 may also analyze the bandwidth available within a connection and provide this information to components as needed. For example, game devices with limited bandwidth may be excluded from a list of seed computing devices. Alternatively, a computing device with limited resources may be given a lower rank for the purpose of use as a seed device.

The player profile data store 344 may work in conjunction with the connection manager 342 to build and store player information. Part of the player profile may comprise demographic and financial information such as a player's name, address and credit card information or other mechanism for purchasing games and experiences provided by the game service.

In addition, the player profile data store 344 may store a player's progress within an individual game. A player's score, achievements, and progress through game levels may be stored. Further, the player profile data store 344 may store information about individual player preferences such as language preferences. The player may access the game level information from multiple clients. For example, the player's progress could be accessed from a friend's game console or on the player's mobile device.

Information regarding a player's game device and speed of the network connection may also be stored in the player profile data store 344 and utilized to optimize the gaming experience and content sharing. For example, in one embodiment, when a geographically proximate data center is busy, players with higher latency Internet connections may be preferentially connected to a peer device that has a high bandwidth connection that creates little additional latency, while players with lower latency connections may be connected to peers that are further away or have slower connections that cause more latency. In this way, the players with the network connections that are best able to handle the additional latency are connected to data centers or peer devices that create additional latency.

The player profile data store 344 may also store a usage history for the individual player such as a player's history of purchasing games or downloading content. From time to time, content available through a player's game devices may be evaluated and recorded within the player profile data store 344. For example, a user may have downloaded a game, but deleted the game from the game device. The deleted game is not available for sharing with other peer devices. Thus, the player profile data store 344 may record what content is actually available for sharing from individual game devices.

The game data store 346 stores available games. The games may be retrieved from the data store and loaded into active memory on a game server or game device for use in a game session. The game data store 346 may be described as passive or secondary memory. In general, games may not be played off of the game data store 346. Games may be communicated from the game data store 346 to the game devices where the game is stored.

The social network component 348 tracks social relationships between users and the devices that are associated with the users. The social network component 348 may determine whether one or more devices are socially affiliated. The social relationships may be communicated to game devices for the purpose of allowing the game device to determine which devices to seek resources from and which devices to grant access to resources. The social network component 348 may provide an interface through which a user is able to explicitly create social relationships. The social relationships may be created by granting access to one or more social networks, contact lists, or communications. The social network component 348 may give the user the opportunity to opt in or opt out of use of social network data to manage content sharing.

The preference manager 350 manages seeing and leeching preferences. As mentioned previously, the preferences may be established by a user. The preferences may be set at different levels of granularity. For example, one group of social relations may be given higher priority to computing resources than another group. The preference manager 350 may provide an interface through which a user is allowed to grant sharing preferences. Game devices may have a similar interface through which sharing preferences are specified. When sharing preferences are established on a game device, a notification may be sent to the preference manager 350 that acts as a central repository for sharing preferences. Newly established preferences may be propagated to all of a user's client devices. In addition, devices that have become socially affiliated may receive a notification indicating the nature of the sharing preferences granted. The socially affiliated devices may use the notification to determine the best pure device from which to seek resources.

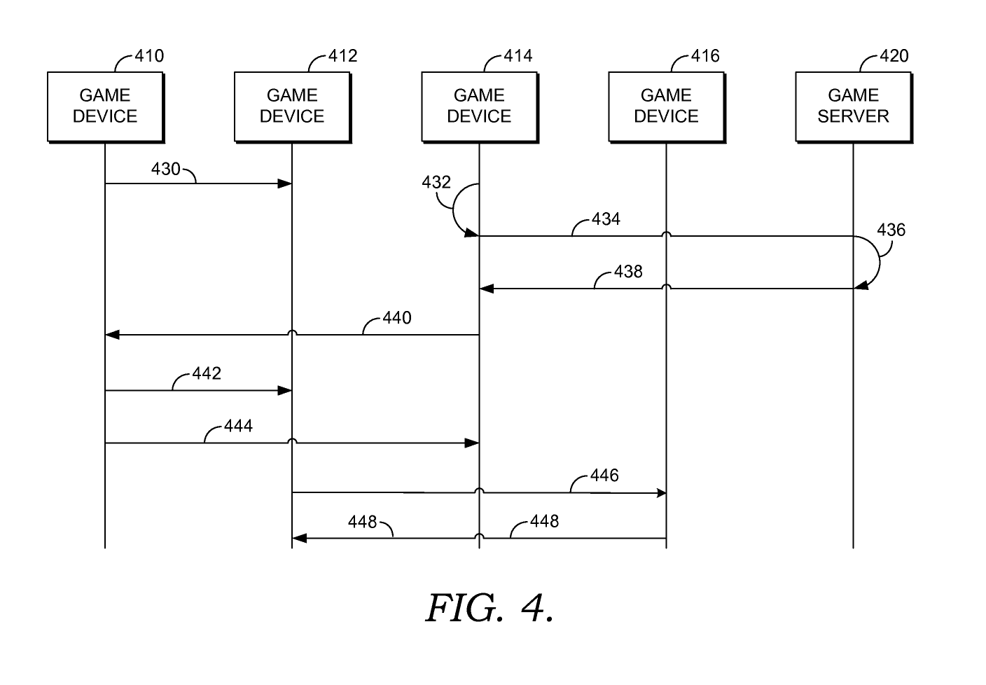

Turning now to FIG. 4, communications incurring within peer-to-peer environment 400 is shown, in accordance with an embodiment of the present invention. The peer-to-peer environment 400 includes game device 410, game device 412, game device 414, and game device 416. The peer-to-peer environment 400 also includes game server 420. Game server 420 could be similar to game server 340 described previously. Embodiments of the present invention may also be used with other content distributors.

Initially, content is communicated from game device 410 to the game device 412. Game device 410 and game device 412 are not socially affiliated for the purpose of this illustration. Game device 410 is acting as a seed and game device 412 is acting as a leech.

Game device 414 receives a request 432 for content. A request for remote content 434 is sent to the game server 420. The game server 420 processes 436 the request and determines that the content requested is available on game device 410. During processing 436, game device 410 may be determined to be socially affiliated with game device 414. The game server 420 instructs the game device 414 to request the content from game device 410.

Game device 414 communicates a request 440 for the content to game device 410. Game device 410 evaluates its sharing preferences and determines that game device 414 is socially affiliated and that game device 412 is not. Game device 410 further evaluates the sharing preferences to determine that nonsocially affiliated game devices are excluded from access to computing resources upon receiving a request or computing resources from a socially affiliated game device. This is just one example of a sharing rule in embodiments of the invention, which are not limited to excluding non-socially affiliated game devices upon receiving a request from a socially affiliated game device. Upon making this determination, a termination notice 442 is communicated to game device 412. The termination notice causes of the content sharing 430 to be terminated. Game device 410 begins sharing content 444 with game device 414.

Game device 412 then seeks a new seed device from which to access content by sending a request for content 446 to game device 416. Game device 416 begins communicating content 448 to game device 412.

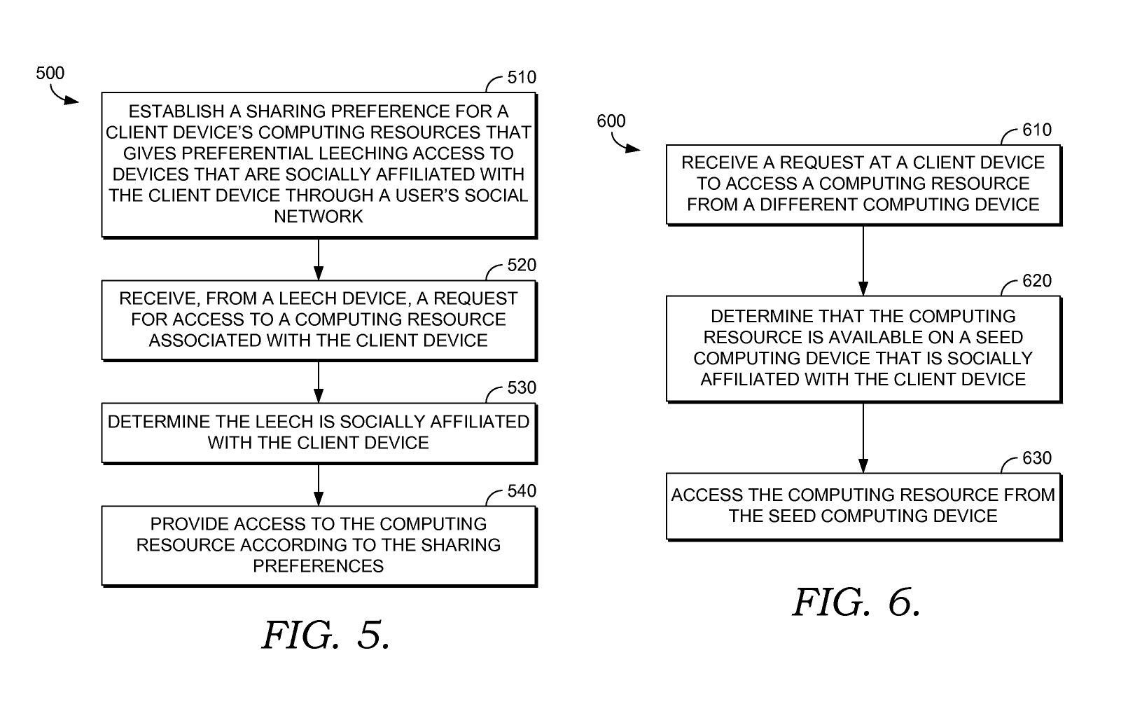

Turning now to FIG. 5, a method 500 of allocating computing resources based on social relationships is provided, in accordance with an embodiment of the present invention. Method 500 may be practiced in a peer-to-peer computing environment. As previously described, social relationships may include formal relationships in a social network, such as Facebook or LinkedIn. Social relationships may also include people in a contact list or frequent correspondence via email, text, or some other form of communication.

At step 510, a sharing preference is established for a client device's computing resources. The sharing preference gives preferential leeching access to devices that are socially affiliated with the client device through a user's social network. In one embodiment, an interface is provided through which a user is able to enumerate the sharing preferences. In addition to enumerating the sharing preferences, the user may add or subtract individuals who are identified as part of the user's social network. Initially, individuals within the user's social network may be automatically determined by analysis of the user's formal social networks, contact lists, and correspondence. In one embodiment, a user may add or subtract individuals to the automatically generated list.

As mentioned, the sharing preferences may differ from individual to individual within a user's social network. To simplify management of sharing preferences, the user may group individuals together and grant a particular type of access to the group as a whole. For example, a group could be established for gaming friends and sharing priorities established around sharing access to game resources with individuals in the gaming friends group.

Groups or individuals may be ranked against one another. In one embodiment, the rank is used to give priority access to groups or individuals with a higher rank. In addition to different priorities, different types of access could be granted to different individuals. For example, some individuals may be given access to archival content while other individuals are excluded. Some individuals may be given permission to wake up the client device from power-saving mode to receive access to computing resources.

Access to computing resources may be given to different groups at different times of the day or week. For example, a first group of individuals may have access 24 hours a day. Other individuals may only have access during work hours when a particular device is likely not to be used by the user.

Once established, the sharing preferences may be stored on the client device and used to evaluate requests for leeching access. Depending on the sharing preferences, a requesting device may be granted access or denied access. The established sharing preferences may also be communicated to the socially affiliated device to which the sharing preferences apply. The receiving device may store the sharing preferences and use those preferences when determining which device to request computing resources from. Additionally, the sharing preferences may be sent to a central repository, such as game server 340 described previously. The central repository may propagate the sharing preferences to the user's other devices and to devices affiliated with users indicated by the sharing preferences.

At step 520, a request from a leech is received. The request is for access to a computing resource associated with the client device. The request may follow the format established for peer-to-peer communications within any given peer-to-peer network. For example, a request may ask that a game or video stored on the client device be communicated to the leech.

At step 530, the leech is determined to be socially affiliated with the client device. This determination may be made by evaluating sharing preferences stored on the client device or by consulting a central repository of sharing preferences. In one embodiment, the request includes a code that validates the social affiliation.

At step 540, access is provided to the computing resources according to the sharing preferences. As mentioned, the sharing preferences may establish parameters for the access. For example, the access may be limited to a threshold amount of available bandwidth. Similarly, the access may limit use to a threshold amount of CPU or GPU processing, active memory use, and the like.

Turning now to FIG. 6, a method 600 of managing allocation of computing resources using social relationships is described, in accordance with an embodiment of the present invention. At step 610, a request is received at the client device to access a computing resource from a different computing device. At step 620, the computing resource is determined to be available on a seed computing device that is socially affiliated with the client device. The social affiliation may be determined by evaluating notifications received from the seed computing device indicating a sharing preference has been established for the computing device. The social affiliation may also be determined by consulting a central repository. In one embodiment, the client device keeps a record of socially affiliated computing devices for use in establishing peer-to-peer connections.

In addition to establishing that the computing device is socially affiliated, the client device may evaluate which of several socially affiliated computing devices to request access from. A user of the client device may establish preferences for seeding devices. The user preferences may be evaluated when determining which socially affiliated computing device should receive the request for computing resources.

Additionally, the performance of computing devices as a seed may be considered when determining which computing device to request resources from. Performance parameters include available bandwidth, latency of a connection, reliability of the connection, hardware compatibility, and hardware capabilities.

At step 630, the computing resources are accessed from a seed computing device. In one embodiment, the computing resources are archived resources such as a game stored on a external hard drive. In another embodiment, the seed computing device is transitioned into an active state from a power saving state in order to share resources. The client device may have a wake-up code that is communicated as part of the initial request. The wake-up code could be provided by a central repository or as part of the initial sharing preferences notification received from the seed computing device.

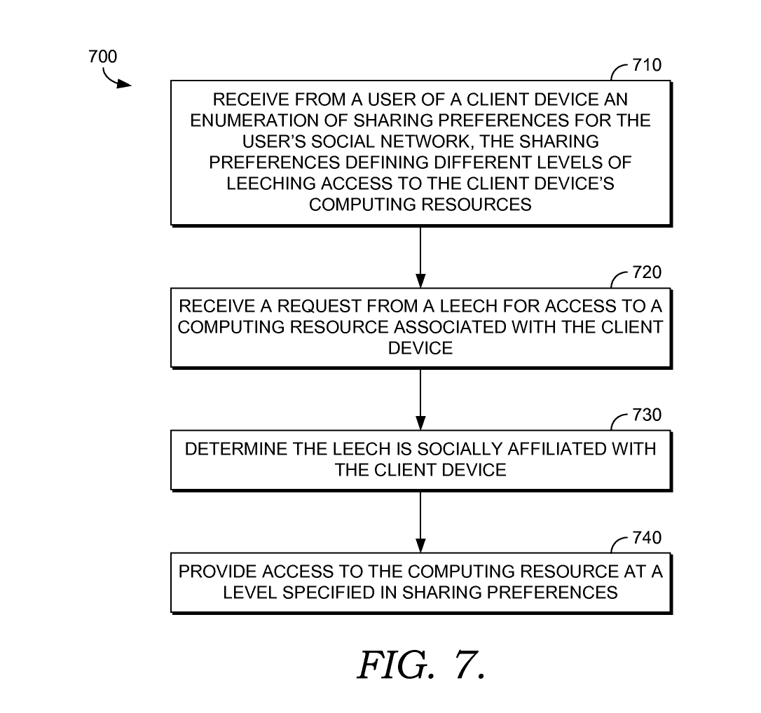

Turning now to FIG. 7, a method 700 of managing access to computing resources based on social relationships is provided, in accordance with an embodiment of the present invention. At step 710, an enumeration of sharing preferences for the user's social network is received from a user of a client device. Sharing preferences defined different levels of leeching access for the client device's computing resources. As mentioned, the enumeration may provide individual-by-individual sharing preferences. At step 720, a request is received from a leech for access to a computing resource associated with the client device. At step 730, the leech is determined to be socially affiliated with the client device. Additionally, a level of sharing preferences specified for the leech may be determined. At step 740, access is provided to the computing resource at a level specified in the sharing preferences.

Embodiments of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer-storage media having computer-executable instructions embodied thereon that when executed by a computing device perform a method of allocating computing resources based on social relationships, the method comprising:
establishing a sharing preference for a client device's computing resources that gives preferential leeching access to devices that are socially affiliated with the client device through a user's social network;
receiving, from a leech device, a request for access to a computing resource associated with the client device;
determining that the leech device is socially affiliated with the client device; and
providing access to the computing resource according to the sharing preference.

2. The media of claim 1, wherein the method further comprises outputting for display, an interface through which the user may enumerate sharing preferences for individuals within the user's social network.

3. The media of claim 1, wherein the method further comprises receiving from the user of the client device an enumeration of sharing preferences for an individual within the user's social network.

4. The media of claim 1, wherein the sharing preference comprises different sharing levels for different individuals in the user's social network.

5. The media of claim 4, wherein the different sharing levels comprise a priority ranking.

6. The media of claim 1, wherein the method further comprises communicating a message to an individual in the user's social network that has been associated with the sharing preference, the message indicating the sharing preference granted and inviting the individual to reciprocate by granting the sharing preference to the user.

7. The media of claim 1, wherein the method further comprises receiving a separate sharing preference that indicates that a leeching preference is granted to the client device by a separate device.

8. A method of managing allocation of computing resources using social relationships, the method comprising:
receiving a request at a client device to access a computing resource from a different computing device;
determining that the computing resource is available on a seed computing device that is socially affiliated with the client device; and
accessing the computing resource from the seed computing device.

9. The method of claim 8, wherein the method further comprises establishing a seeding preference that provides the client device with preferred seed computing devices that are socially affiliated with the client device through a user's social network.

10. The method of claim 8, wherein the method further comprises receiving a notification from the seed computing device that indicates sharing preferences established on the seed computing device grant the client device preferential access to one or more computer resources associated with the seed computing device.

11. The method of claim 8, wherein the computing resource is a file.

12. The method of claim 8, wherein the client device is socially affiliated with the seed computing device because a user of the client device has a social relationship with a user of the seed computing device.

13. The method of claim 12, wherein the social relationship comprises participating in a multi-player game session together.

14. The method of claim 8, wherein the computing resource is accessed at a level specified in sharing preferences set by a user of the seed computing device.

15. A method of managing access to computing resources based on social relationships, the method comprising:
receiving, from a user of a client device, an enumeration of sharing preferences for the user's social network, the sharing preferences defining different levels of leeching access to the client device's computing resources;
receiving a request from a leech for access to a computing resource associated with the client device;
determining that the leech is socially affiliated with the client device; and
providing access to the computing resource at a level specified in sharing preferences.

16. The method of claim 15, wherein the sharing preferences allow a designated number of socially affiliated leeching devices to leech simultaneously.

17. The media of claim 15, wherein the sharing preferences allow socially affiliated leeching devices to consume up to a threshold amount of bandwidth.

18. The media of claim 15, wherein the sharing preferences allows the client device to switch out of power-saving mode in response to a request from a socially affiliated leeching device.

19. The media of claim 15, wherein the sharing preferences grant access to archived content associated with the client device.

20. The media of claim 15, wherein the method further comprises receiving a benefit from a content distributor in response to establishing the sharing preferences.
